(19) United States
(12) Patent Application Publication
(10) Pub. No.: US 2016/0101304 A1
(43) Pub. Date: Apr. 14, 2016

(54) Multi-Blanket Inert Gas Rail Car Fire Suppression

(71) Applicants: Keith A. Langenbeck, Keller, TX (US); Kevin M. Henson, Garland, TX (US)

(72) Inventors: Keith A. Langenbeck, Keller, TX (US); Kevin M. Henson, Garland, TX (US)

(21) Appl. No.: 14/748,177

(22) Filed: Jun. 23, 2015

Related U.S. Application Data
(60) Provisional application No. 62/062,901, filed on Oct. 12, 2014.

(51) Int. Cl. A62C 3/06; A62C 3/07

(52) U.S. Cl. CPC A62C 3/065; A62C 3/07

(57) ABSTRACT

A container ignition and fire suppression system, comprising means for removing volatile gases present prior to and produced during and after loading the container with a volatile liquid based on a weight capacity of the container; filling a headspace above a level of the volatile liquid with a blanket composition of inert gas(es); pressurizing the volatile liquid and the predetermined composition of inert gas(es) to a predetermined pressure to retard outgassing of the volatile liquid into the head space occupied by the inert gas(es); discharging a fire retardant foam at onset of a rupturing of the predetermined blanket composition, the discharge adapted to smother, extinguish and prevent a fire from igniting via a spark, a rupture and other combustible processes; and a monitor and control apparatus adapted to determine and adjust a plurality of conditions regarding the inert gas(es) and the volatile liquid in the container via telemetry.

### CROSS-REFERENCE TO RELATED APPLICATION

This application claims the benefit of the priority date of earlier filed U.S. Provisional Patent Application Ser. No. 62/062,901, titled ‘Fire Suppression System for Railroad Tankers and Other Vehicles’ filed Oct. 12, 2014 by Keith A. Langenbeck, and is incorporated herein by reference in its entirety.

### BACKGROUND OF THE INVENTION

Most of the general-purpose railroad tank cars in use are designated by the classification of DOT-111. These DOT-111 tankers are used extensively for hauling ethanol, crude oil and other volatile liquids to refineries and transshipment ports throughout North America. The dramatic increase of Crude By Rail (CBR) shipments in the past years has also resulted in derailments with catastrophic consequences as seen in the Lac-Megantic, Ontario disaster on Jul. 6, 2013, in which thirty of the sixty-three derailed tank cars suffered head or shell punctures. Forty-seven lives were lost in that Canadian disaster in July of 2013.

Investigations into CBR derailments have brought intense scrutiny to how trains are routed, the crash worthiness of the DOT-111 tankers, the fundamental problems with the track structure that can cause derailments, safety and maintenance procedures of railroad operations and other areas. DOT-111 tank cars are single wall vessels that are designed for transporting non-pressurized liquids. Tanker cars used to transport propane, butane, LNG and other pressurized liquids employ thicker steel, double wall construction and other design differences when compared to the DOT-111.

Crude oil from the relatively new Bakken oil field in North Dakota is apparently more volatile than crude oil from historic oil fields in Texas, Oklahoma, Louisiana and other states. It has a greater propensity to off-gas/out-gas methane and light molecular weight natural gas liquids (NGL), also known as liquid petroleum gases (LPG). The explosion risk of DOT-111 tankers is further exacerbated by: (1) agitation of the liquids during long transport distances, (2) wide ambient temperature differences from North Dakota to the Gulf Coast and (3) tankers are commonly painted black, which absorbs solar radiation, heats the steel and internal fluids above ambient temperature, stimulating the release of volatile gases into the tanker headspace during transit.

Crude oil can contain varying amounts of hydrogen sulfide in its composition. Sweet crude has relatively small amounts of sulfur and sour crude has greater amounts of sulfur. Hydrogen sulfide is not only highly toxic and explosive but also corrosive to common steel alloys.

Therefore a market need for a safe and economical way to transport hydrocarbon fuels has existed but has gone unmet by the presently available designs.

### SUMMARY OF THE INVENTION

A container ignition and fire suppression method, apparatus and system is disclosed. The disclosure includes means for removing volatile gases present prior to and produced during and after loading the container with a volatile liquid based on a weight capacity of the container; filling a headspace above a level of the volatile liquid with a blanket composition of inert gas(es); pressurizing the volatile liquid and the predetermined composition of inert gas(es) to a predetermined pressure to retard outgassing of the volatile liquid into the head space occupied by the inert gas(es); discharging a fire retardant foam and the like at onset of a rupturing of the predetermined blanket composition, the discharge of the fire retardant foam adapted to smother, extinguish and prevent a fire from igniting via a spark, a rupture and other combustible processes; and a monitor and control apparatus adapted to determine and adjust a plurality of conditions regarding the inert gas(es) and the volatile liquid in the container via telemetry.

The container ignition and fire suppression apparatus, method and system may include a railroad tanker car configured for the transportation of volatile liquids and fluids. The container may also comprise a trailer configured for liquid and volatile fluids transport. The container may also comprise an airborne tanker for the transportation and deployment of volatile liquids and fluids. The container may additionally include a water borne tanker for the transportation and deployment of volatile liquids and fluids. The container may yet include any of a stationary storage tank for storage of volatile liquids and fluids.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is a schematic representation of a system for multi-blanket composition of inert gases for a container ignition and fire suppression system in accordance with an embodiment of the present disclosure.

FIG. 2 is a flow-chart diagrammatic representation of a system for multi-blanket composition of inert gases including additional blanket layers for a container ignition and fire suppression system in accordance with an embodiment of the present disclosure.

FIG. 3 is a simple length wise sectional representation of a railroad tank car comprising a blanket composition of inert gases for container ignition and fire suppression system in accordance with an embodiment of the present disclosure.

FIG. 4 is a simple length wise sectional representation of a railroad tank car comprising a two blanket composition of inert gases for a container ignition and fire suppression system in accordance with an embodiment of the present disclosure.

FIG. 5 is a simple length wise sectional representation of a railroad tank car comprising a multi-blanket composition of inert gases including also a baffle for a container ignition and fire suppression system in accordance with an embodiment of the present disclosure.

FIG. 6 is a simple length wise sectional representation of a railroad tank car comprising a multi-blanket composition of inert gases including also a baffle and a discharge blanket layer for a container ignition and fire suppression system in accordance with an embodiment of the present disclosure.

FIG. 7 is a simple length wise sectional representation of a railroad tank car comprising a blanket composition of inert gases including an overflow for a container ignition and fire suppression system in accordance with an embodiment of the present disclosure.

FIG. 8 is a block schematic representation of a system for multi-blanket composition of inert gases including additional blanket layers for a container ignition and fire suppression system in accordance with an embodiment of the present disclosure.

Throughout the description, similar or same reference numbers may be used to identify similar or same elements in the several embodiments and drawings. Although specific embodiments of the invention have been illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure and continuances and/or divisional disclosures thereof, the term ‘blanket’ refers to a fluid layer or a gaseous layer or a hybrid composition layer thereof between a volatile liquid and something else, most generally the inside of a container. ‘Blanket’ is a layer which in this case isolates a volatile liquid from oxygen and therefore prevents, inhibits combustion and suffocates any ignition of a spark or a flame. The terms ‘spark’ and ‘ignition’ and ‘fire’ are not always synonymous but are connoted in context in respective description and claims herein.

Unknown in the transportation of crude oil, ethanol and other explosive liquids are means or methods for evacuating, exchanging or purging the air and accumulated volatile vapors from the tanker car headspace during or after the loading process. Current crude by rail (CBR) operations allow for volatile gases to mix with atmospheric oxygen, creating an explosive fuel-air mixture. The disclosure claims the use of inert gases like Nitrogen and Carbon Dioxide to effectively eliminate the headspace explosion risk during loading/unloading operations and accidents. DOT-111 tankers are considered non-pressurized vessels, but they can experience vapor pressure levels as much as 75 psi, at which common pressure relief valves are set to discharge.

In addition to and coordination with inert gasses being added to the headspace of the railroad tankers, this invention includes: (1) supervisory control and data acquisition systems to monitor, communicate and operate the inert gas conditions of the head space, (2) control and data acquisition systems to monitor and communicate the operational and risk status of the tanker car, (3) control and data acquisition systems to monitor, communicate and operate on-board fire suppression systems in the case of derailment or high risk conditions, (4) on-board mechanical systems for adding or adjusting inert gas conditions in the head space, (5) on-board mechanical systems for active fire suppression, (6) onboard means to power and operate the various listed functions, (7) coating the railroad tankers to reflect infrared, solar radiation to prevent excess heat from being added to the volatile liquids and (8) application of the herein described integrated systems for use with vehicles used in road, water and other transportation means.

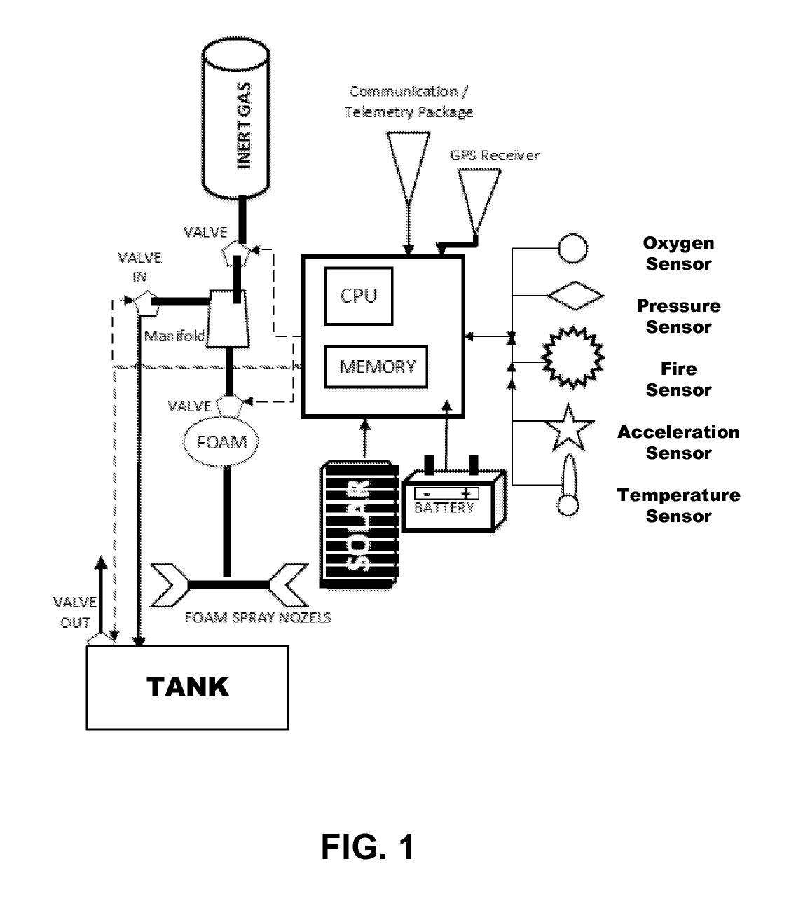

FIG. 1 is a schematic representation of a system for multi-blanket composition of inert gases for a container ignition and fire suppression system in accordance with an embodiment of the present disclosure. The schematic includes an oxygen sensor, a pressure sensor, a fire sensor, an acceleration sensor and a temperature sensor. The Acceleration sensor determines a change of rate for direction and speed of motion for the container. If either a change of rate for direction or speed of motion of the container is detected then the system maintains the ignition and fire suppression for the container. The schematic also includes a valve out of the container tank, a valve in, a manifold, a valve to the inert gas, a valve to the fire retardant foam, a Central Processor and associated memory for digital processing of telemetry data and communication via a Global Positioning Satellite receiver and a Communication/Telemetry Package. Solar cells and/or a battery provide power to the system or the power may be taken from the respective transportation system. Communication and electrical coupling of the schematic entities is depicted by schematic lines and arrows but does not limit inter and intra communication of the depicted components.

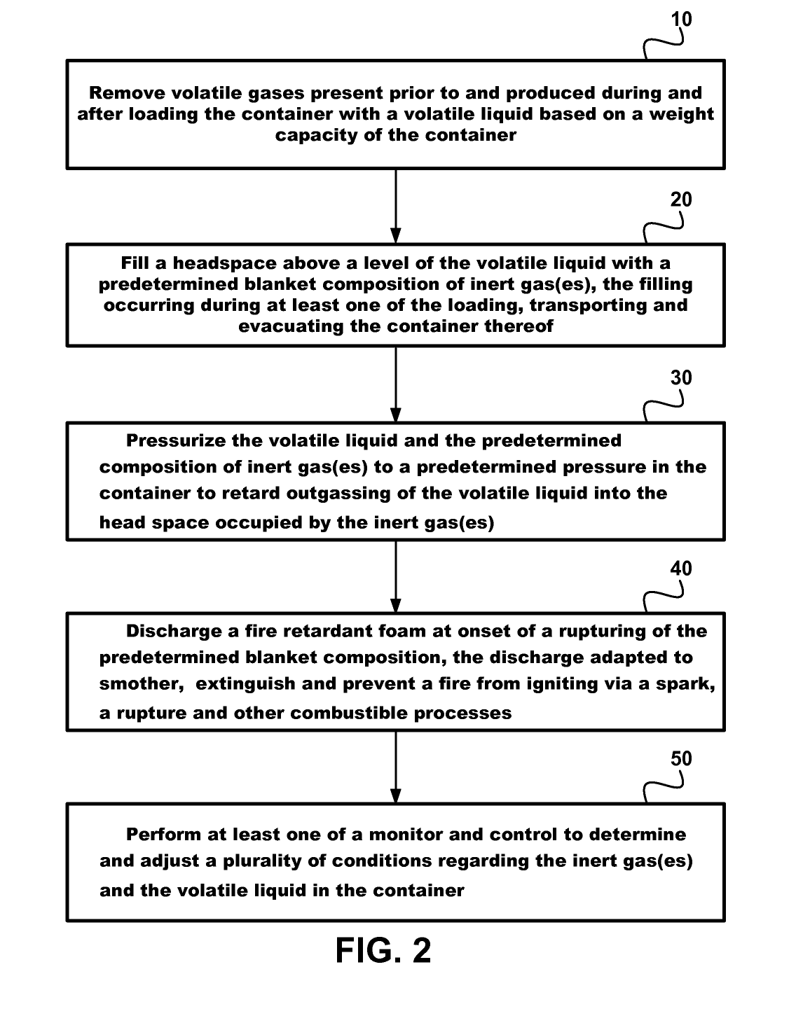

FIG. 2 is a flow-chart diagrammatic representation of a system for multi-blanket composition of inert gases including additional blanket layers for a container ignition and fire suppression system in accordance with an embodiment of the present disclosure. The container ignition and fire suppression method disclosed comprises removing 10 volatile gases present prior to and produced during and after loading the container with a volatile liquid based on a weight capacity of the container. The method also includes filling 20 a headspace above a level of the volatile liquid with a predetermined blanket composition of inert gas(es), the filling occurring during at least one of the loading, transporting and evacuating the container thereof. The method further includes pressurizing 30 the volatile liquid and the predetermined composition of inert gas(es) to a predetermined pressure in the container to retard outgassing of the volatile liquid into the head space occupied by the inert gas(es).

An embodiment of the container spark and fire suppression method further comprises discharging 40 a fire retardant foam and the like at onset of a rupturing of the predetermined blanket composition, the discharge adapted to smother, extinguish and prevent a fire from igniting via a spark, a rupture and other combustible processes. The embodiment also includes performing 50 at least one of a monitor and control to determine and adjust a plurality of conditions regarding the inert gas(es) and the volatile liquid in the container.

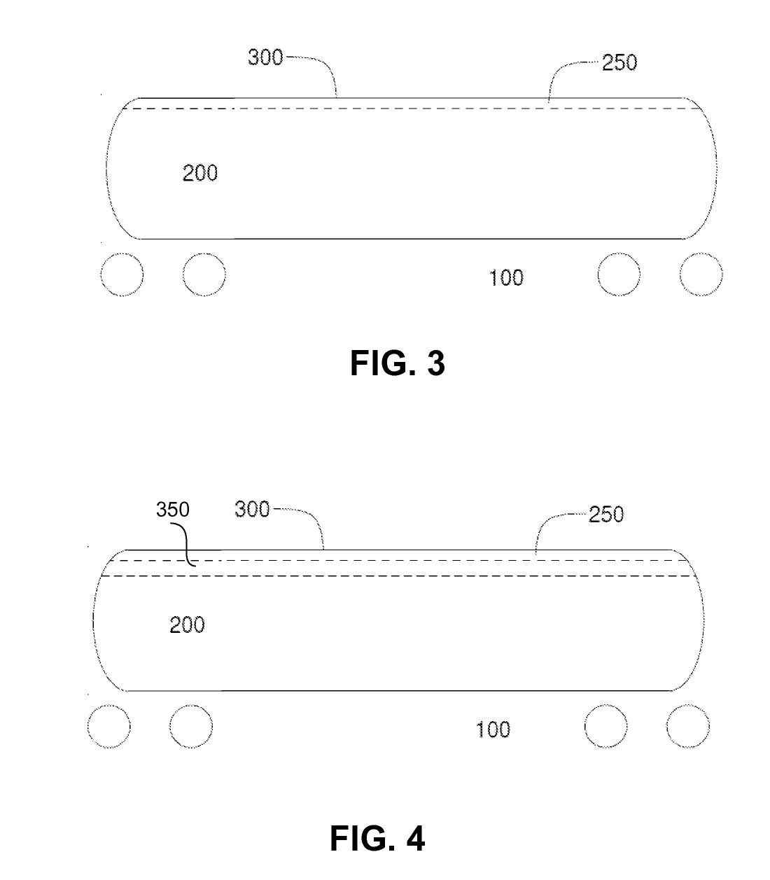

FIG. 3 is a simple cross sectional representation of a railroad tank car comprising a blanket composition of inert gases for container ignition and fire suppression system in accordance with an embodiment of the present disclosure. When Item 100 is filled to weight capacity with crude oil, ethanol or other explosive liquids, Item 200, a portion of the interior volume remains empty creating a headspace, Item 250, into which explosive gases can migrate. Disclosed within and anticipated by this application are certain systems, Item 300, that would among other things: (1) evacuate, remove or purge some or all of the volatile gases and air during or after the filling, (2) fill the headspace above the liquid level with inert gases during or after filling or when fluids are being unloaded, (3) pressurize the inert gases sufficient to prevent or retard the out-gassing of the volatile liquids into the head space and (4) other safety benefits commonly lacking when DOT-111 tanker cars are used to transport volatile liquids.

FIG. 4 is a simple lengthwise sectional representation of a railroad tank car comprising a two blanket composition of inert gases for a container spark and fire suppression system in accordance with an embodiment of the present disclosure. Reference numbers for FIG. 3 may be the same for same and/or similar features depicted in FIG. 2 and elsewhere in the disclosure. The removing of volatile gases may occur during loading of the container with the volatile liquid and includes exchanging a volume occupied by the volatile gases with a volume occupied by the loaded volatile liquid. The blanket composition of inert gases comprises at least one of carbon dioxide, nitrogen and the noble gases helium, neon, argon, krypton, xenon and radon to a predetermined immiscibility of the inert gas(es) into the volatile liquid. The blanket composition of inert gases also comprises a two blanket composition of at least one of carbon dioxide and nitrogen and at least one of a molecularly heavier noble gas 350 which sits between the volatile liquid and at least one of the carbon dioxide and the nitrogen. A heavier molecular gas may have a higher atomic number and/or have more atomic bonds in a molecule. The heavier noble gas may be more expensive than the inert gas(es) sitting adjacent thereto in the headroom 250 and therefore the double or duo layer of predetermined composite gas(es) is more economical than filling the entire headroom 250 with the noble gas(es).

A further embodiment of the container ignition and fire suppression apparatus, comprises means for removing any volatile gases present prior to and produced during and after loading the container with a volatile liquid based on a weight capacity of the container. The embodiment also includes means for filling a headspace above a level of the volatile liquid with a predetermined blanket composition of inert gas(es), the filling occurring during at least one of the loading, transporting and evacuating the container thereof. The embodiment additionally includes means for pressurizing the volatile liquid and the predetermined composition of inert gas(es) to a predetermined pressure in the container to retard outgassing of the volatile liquid into the head space occupied by the inert gas(es). The embodiment further includes means for discharging a fire retardant foam and the like at onset of a rupturing of the predetermined blanket composition, the discharge adapted to smother, extinguish and prevent a fire from igniting via a spark, a rupture and other combustible processes.

An embodiment of the means for filling that acts through the top inside of the container from an outside thereof is disclosed. The filling means is adapted to exchange a volume occupied by the volatile gases with a volume occupied by the composition of inert gas(es).

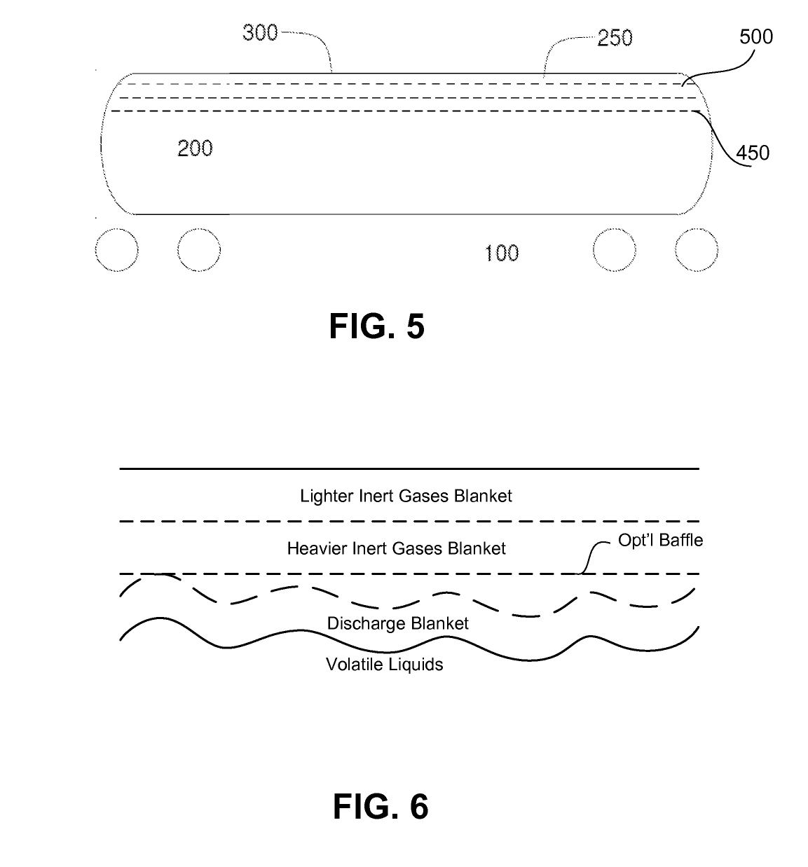

FIG. 5 is a simple cross sectional representation of a railroad tank car comprising a multi-blanket composition of inert gases including also a baffle for a container ignition and fire suppression system in accordance with an embodiment of the present disclosure. The container ignition and fire suppression apparatus may further comprise means for refrigerating the headspace above the level of the volatile liquid and refrigerating the predetermined blanket composition of inert gas(es). Also, a baffle blanket 450 may be disposed above the level of the volatile liquid, the baffle blanket adapted to allow the predetermined blanket composition of inert gas(es) to fill and maintaine the headspace during any transporting motion.

FIG. 6 details the multiple blankets that layer the volatile fluid. The lighter inert gases may be disposed adjacent an inner topside of the container. The heavier noble gases and heavier molecular compositions may be adjacent the lighter gas(es). The optional baffle may be adjacent the heavier gases or the lighter gases depending on the present of both types of filler. The volatile liquid(s) may be adjacent the baffle or the heavier gases or the lighter gases absent the heavier gases. A foam discharge blanket may be adjacent the volatile liquids in the event a discharge has issued to prevent, retard or extinguish a spark, a flame or an eminent conflagration. Therefore, one or multiple suppression blanket layers may be present depending on the economy, the distance to transport the volatile liquid and flammable events occurring in transit.

The container ignition and fire suppression apparatus further comprises an electro-mechanical monitor and control apparatus configured to determine and adjust a plurality of conditions regarding the inert gas(es) and the volatile liquid in the container. The electro-mechanical apparatus and telemetry may sense an eminent flammability of the volatile liquid and act to suppress, retard and extinguish such an event or occurrence. The disclosed apparatus further comprises at least one valve in the container configured to maintain the predetermined pressure therein above a pressure at which the valve is designed to discharge fluid there through.

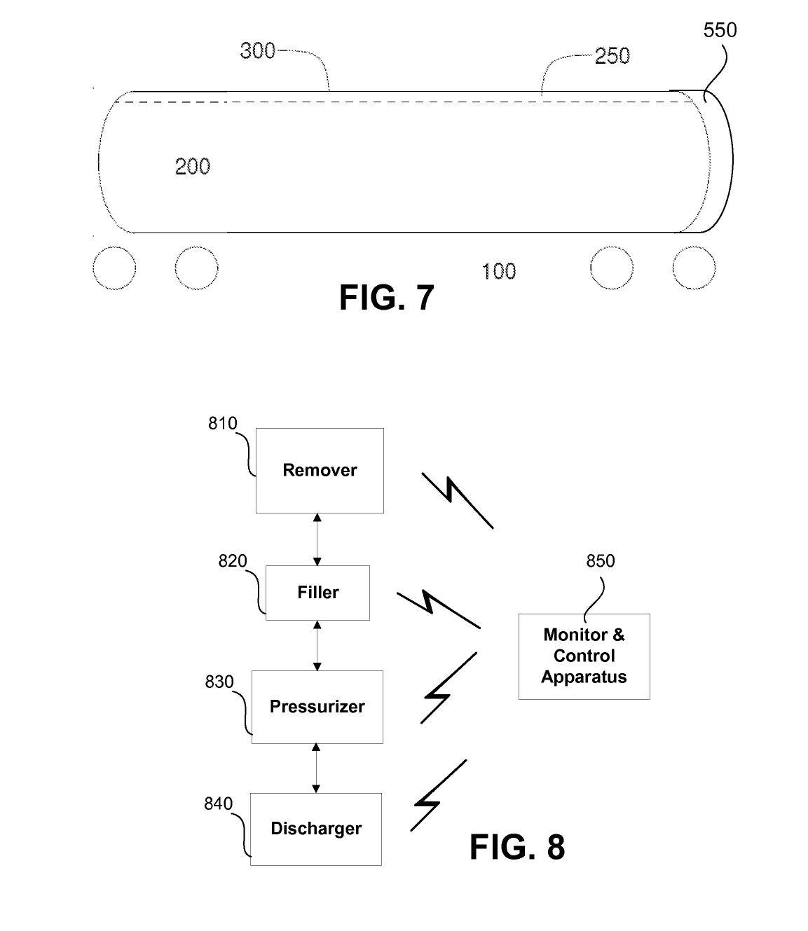

FIG. 7 is a simple lengthwise sectional representation of a railroad tank car comprising a blanket composition of inert gases including an overflow for a container ignition and fire suppression system in accordance with an embodiment of the present disclosure. An overflow chamber adjacent the container is included in an embodiment. The overflow chamber 550 is adapted to retain any inert gas(es) and volatile fluid during a thermo-expansion of the volatile liquid through a discharge valve in the container.

Embodiments of the container spark and fire suppression apparatus include a railroad tanker car configured for the transportation of volatile liquids and fluids, a trailer for volatile liquid and volatile fluids transport, an airborne tanker for the transportation and deployment of volatile liquids and fluids, a water borne tanker for the transportation and deployment of volatile liquids and fluids and any of a stationary storage tank for storage of volatile liquids and fluids.

FIG. 8 is a block schematic representation of a system for multi-blanket composition of inert gases including additional blanket layers for a container ignition and fire suppression system in accordance with an embodiment of the present disclosure. A container ignition and fire suppression system comprises a remover 810 adapted to remove volatile gases present prior to and produced during and after loading the container with a volatile liquid based on a weight capacity of the container. The system also includes a filler 820 adapted to fill a headspace above a level of the volatile liquid with a predetermined blanket composition of inert gas(es), the filling occurring during at least one of the loading, transporting and evacuating the container thereof. The system additionally includes a pressurizer 830 adapted to pressurize the volatile liquid and the predetermined composition of inert gas(es) to a predetermined pressure in the container to retard outgassing of the volatile liquid into the head space occupied by the inert gas(es). The system further includes a discharger of a fire retardant foam and the like at onset of a rupturing of the predetermined blanket composition, the discharge adapted to smother, extinguish and prevent a fire from igniting via a spark, a rupture and other combustible processes. The system yet includes at least one of a monitor and control apparatus 850 adapted to determine and adjust a plurality of conditions regarding the inert gas(es) and the volatile liquid in the container. The monitor and control apparatus is also adapted to communicate telemetry information to an operator and/or an operations device to allow remote operations thereof. Telemetry data may include data for a plurality of conditions including but not limited to temperature, pressure, weight and volume for both the volatile liquid and the inert gas(es).

In an embodiment of the disclosed system, a coating on the container is adapted to reflect infrared and solar radiation to prevent excess heat from being added to the volatile liquid.

The present disclosure therefore fills the long felt need for an efficient and economical railcar fire suppression apparatus, method and system. The unique features and novel inventions within this disclosure have various applications and are not limited in scope to the uses described herein. Although the components herein are shown and described in a particular order, the order thereof may be altered so that certain advantages or characteristics may be optimized. In another embodiment, instructions or sub-operations of distinct steps may be implemented in an intermittent and/or alternating manner.

Notwithstanding specific embodiments of the invention have been described and illustrated, the invention is not to be limited to the specific forms or arrangements of parts so described and illustrated. The scope of the invention is to be defined by the claims and their equivalents.

What is claimed is:

1. A container spark and fire suppression method, comprising:
removing volatile gases present prior to and produced during and after loading the container with a volatile liquid based on a weight capacity of the container;
filling a headspace above a level of the volatile liquid with a predetermined blanket composition of inert gas(es), the filling occurring during at least one of the loading, transporting and evacuating the container thereof; and
pressurizing the volatile liquid and the predetermined composition of inert gas(es) to a predetermined pressure in the container to retard outgassing of the volatile liquid into the head space occupied by the inert gas(es).

2. The container spark and fire suppression method of claim 1, wherein the removing occurs during loading the container with the volatile liquid and exchanging a volume occupied by the volatile gases with a volume occupied by the loaded volatile liquid.

3. The container spark and fire suppression method of claim 1, wherein the blanket composition of inert gases comprises at least one of carbon dioxide, nitrogen and the noble gases helium, neon, argon, krypton, xenon and radon to a predetermined immiscibility of the inert gas(es) into the volatile liquid.

4. The container spark and fire suppression method of claim 1, further comprising a multiple blanket composition of inert gases comprises at least one of carbon dioxide and nitrogen and at least one of a molecularly heavier noble gas which sits between the volatile liquid and at least one of the carbon dioxide and the nitrogen.

5. The container spark and fire suppression method of claim 1, further comprising discharging a foam blanket and the like at onset of a rupturing of the predetermined blanket composition, the discharge adapted to smother, extinguish and prevent a fire from igniting via a spark, a rupture and other combustible processes.

6. The container spark and fire suppression method of claim 1, further comprising refrigerating the headspace above the level of the volatile liquid and refrigerating the predetermined blanket composition of inert gas(es).

7. A container spark and fire suppression apparatus, comprising:
means for removing any volatile gases present prior to and produced during and after loading the container with a volatile liquid based on a weight capacity of the container;
means for filling a headspace above a level of the volatile liquid with a predetermined blanket composition of inert gas(es), the filling occurring during at least one of the loading, transporting and evacuating the container thereof;
means for pressurizing the volatile liquid and the predetermined composition of inert gas(es) to a predetermined pressure in the container to retard outgassing of the volatile liquid into the head space occupied by the inert gas(es); and
means for discharging a fire retardant foam and the like at onset of a rupturing of the predetermined blanket composition, the discharge adapted to smother, extinguish and prevent a fire from an ignition, a rupture and other combustible processes.

8. The container spark and fire suppression apparatus of claim 7, further comprising an electro-mechanical monitor and control apparatus configured to determine and adjust a plurality of conditions regarding the inert gas(es) and the volatile liquid in the container.

9. The container spark and fire suppression apparatus of claim 7, further comprising a baffle blanket disposed above the level of the volatile liquid, the baffle blanket adapted to allow the predetermined blanket composition of inert gas(es) to fill and maintain the headspace during any transporting motion.

10. The container spark and fire suppression apparatus of claim 7, further comprising at least one valve in the container configured to maintain the predetermined pressure therein at less than or equal to 75 psi above which the valve is designed to discharge fluid there through.

11. The container spark and fire suppression apparatus of claim 7, wherein the means for filling is adapted to produce the predetermined blanket composition of inert gases comprising two blankets of at least one of carbon dioxide and nitrogen and at least one of a molecularly heavier noble gas which sits between the volatile liquid and at least one of the carbon dioxide and the nitrogen.

12. The container spark and fire suppression apparatus of claim 7, further comprising an overflow chamber adjacent the container, the overflow chamber adapted to retain any inert gas(es) and volatile fluid during a thermo-expansion of the volatile liquid through a discharge valve in the container.

13. The container spark and fire suppression apparatus of claim 7, wherein the container is a railroad tanker car configured for the transportation of volatile liquids and fluids.

14. The container spark and fire suppression apparatus of claim 7, wherein the container is a trailer of a tractor-trailer volatile liquid and volatile fluids transport.

15. The container spark and fire suppression apparatus of claim 7, wherein the container is one of an airborne tanker and a water borne tanker for the transportation and deployment of volatile liquids and fluids.

16. The container spark and fire suppression apparatus of claim 7, wherein the container is any of a stationary storage tank for storage of volatile liquids and fluids.

17. A container spark and fire suppression system, comprising:
a remover adapted to remove any volatile gases present prior to and produced during and after loading the container with a volatile liquid based on a weight capacity of the container;
a filler adapted to fill a headspace above a level of the volatile liquid with a predetermined blanket composition of inert gas(es), the filling occurring during at least one of the loading, transporting and evacuating the container thereof;
a pressurizer adapted to pressurize the volatile liquid and the predetermined composition of inert gas(es) to a predetermined pressure in the container to retard outgassing of the volatile liquid into the head space occupied by the inert gas(es); and
at least one of a monitor and control apparatus adapted to determine and adjust a plurality of conditions regarding the inert gas(es) and the volatile liquid in the container.

18. The container spark and fire suppression system of claim 17, wherein the at least one of a monitor and a control apparatus comprises an electro-mechanical monitor and control apparatus configured to determine and adjust a plurality of conditions regarding the inert gas(es) and the volatile liquid in the container.

19. The container spark and fire suppression system of claim 17, wherein the monitor and control apparatus is also adapted to communicate and telemetry information to an operator and/or an operations device to allow remote operations thereof.

20. The container spark and fire suppression system of claim 17, further comprising a coating on the container adapted to reflect infrared, solar radiation to prevent excess heat from being added to the volatile liquid.
